(19) United States
(12) Patent Application Publication
(10) Pub. No.: US 2011/0048008 A1
(43) Pub. Date: Mar. 3, 2011

(54) Hydro-Electric reactor

(76) Inventor: Gabriel Ohiochoya Obadan, Pasadena, CA (US)

(21) Appl. No.: 12/583,713

(22) Filed: Aug. 25, 2009

(51) Int. Cl. F02C 1/02; F03G 7/10

(52) U.S. Cl. 60/645; 415/916

(57) ABSTRACT

The Hydro-Electric Reactor is a renewable and reliable green energy technology which uses only ambient air from the atmosphere, indoors or outdoors, to generate electricity through four stages of air compression known as the Multiple-Compression-Propulsion-System that enables pressurized air to be driven through a network of specially designed Micro-Turbines which are attached to electricity generators through shafts that rotate rapidly when the pressurized air turn the Micro-Turbines, to generate electricity in commercial quantities.

### BRIEF DESCRIPTION

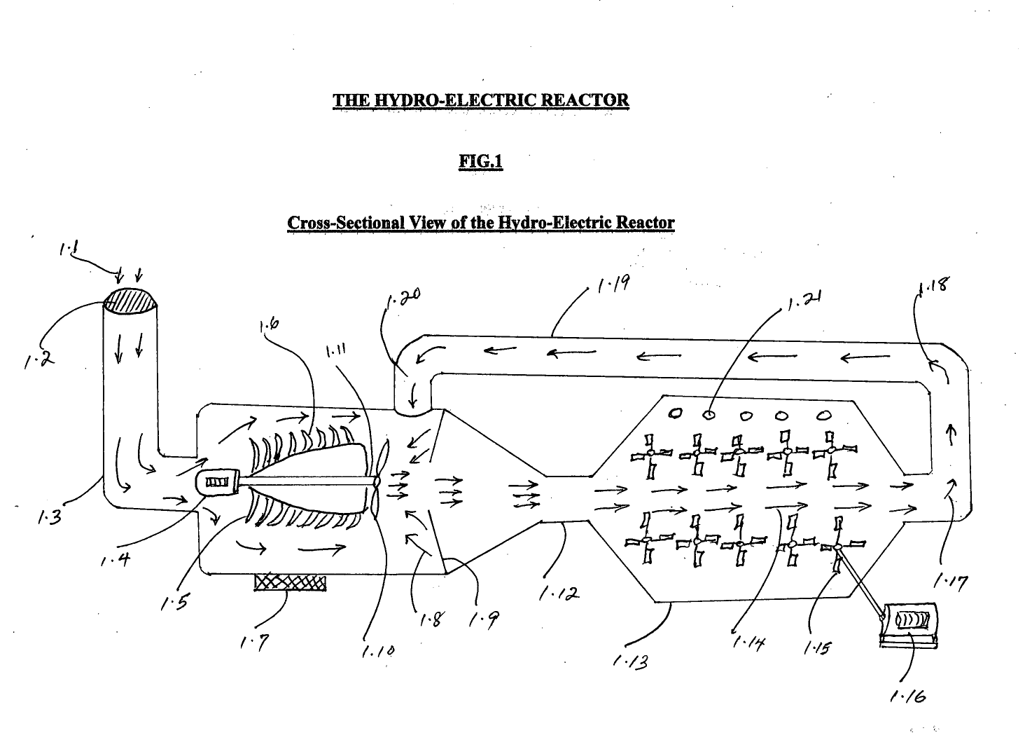

FIG. 1 Shows a cross-sectional view of the Hydro-Electric Reactor power plant indicating the Vertical Air-Intake Safety Vent which allows air to be drawn vertically into the system and it provides safety from particles being sucked into the power plant. The incoming air is compressed through several stages of compressors and forced under extreme pressure into the Multiple-Compression Chamber which further propels the compressed air, through a nozzle, to drive a series of specialized turbines that are attached to generators through shafts. The rotary motion created by the revolving turbines activates the generators through connecting shafts.

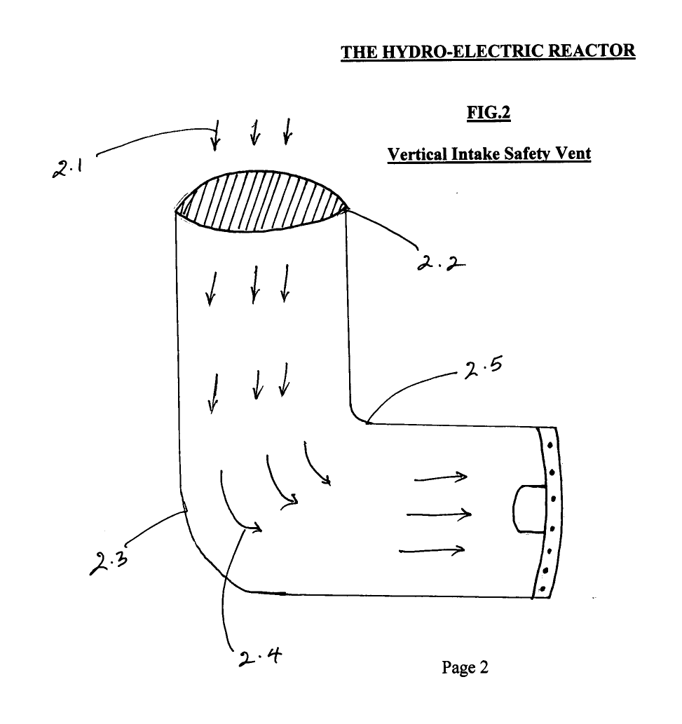

FIG. 2 Is a side view of the Vertical Air-Intake Safety Vent and it is shaped like a vertical funnel to provide maximum safety from objects standing in front or the sides of the power plant from being sucked into the system.

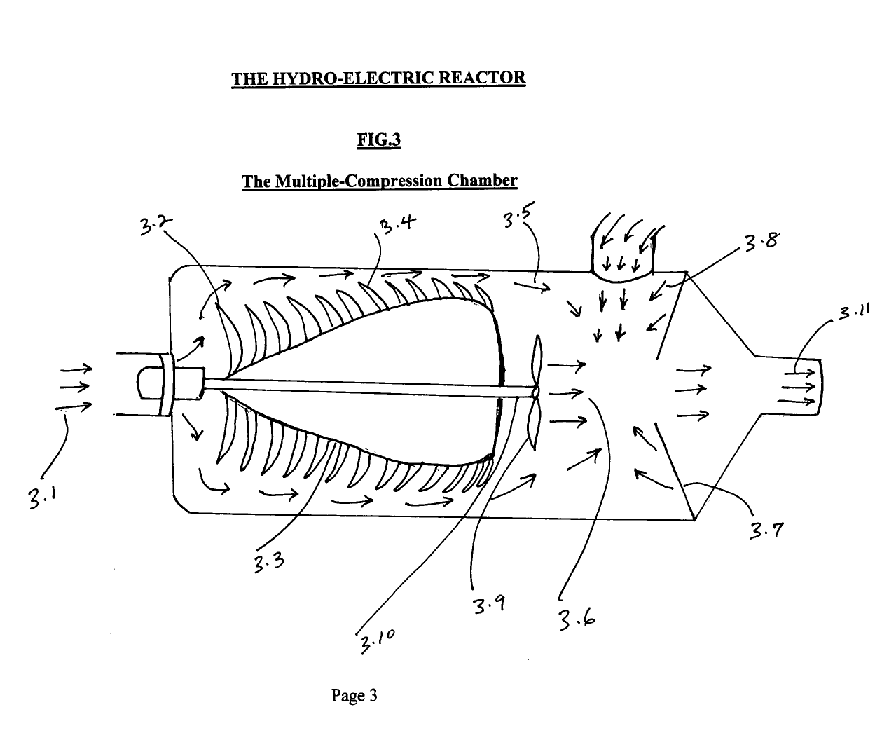

FIG. 3 Is a cross-sectional view of the Multiple-Compression Chamber which compresses incoming air to provide enough pressure and velocity necessary to turn or spin the specialized turbine contained inside the Jet-Propulsion Corridor.

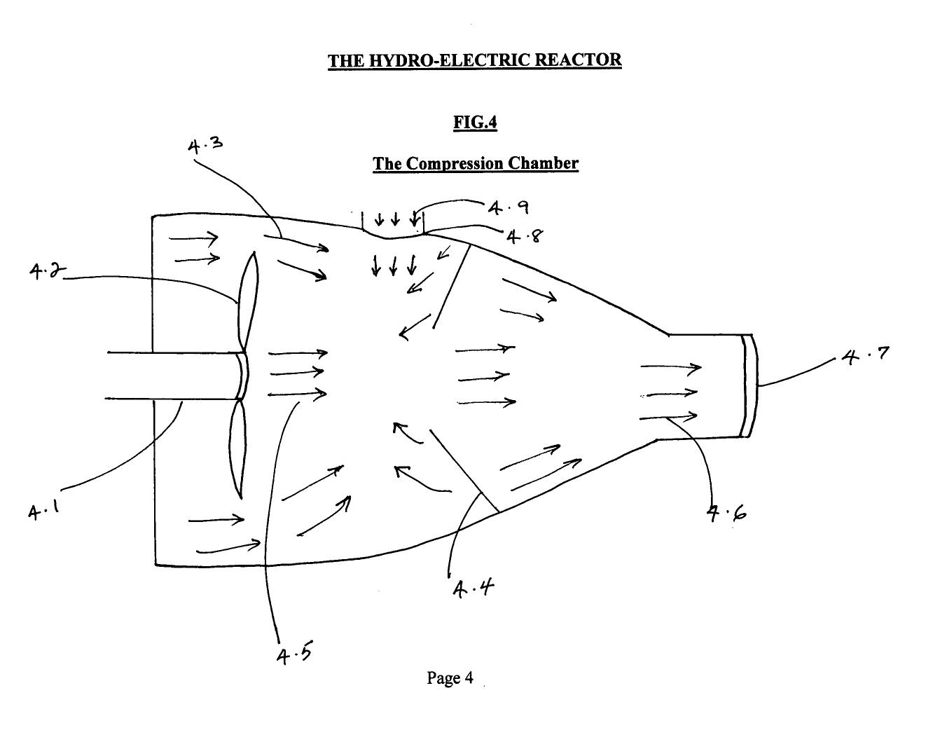

FIG. 4 Is a side view of the second half of the Multiple-Compression Chamber which is designed to replace the internal combustion chamber inside a conventional jet engine. Its purpose is to multiply the volume of air through multiple compression and to force the extremely compressed air into the next chamber using a back-end propeller.

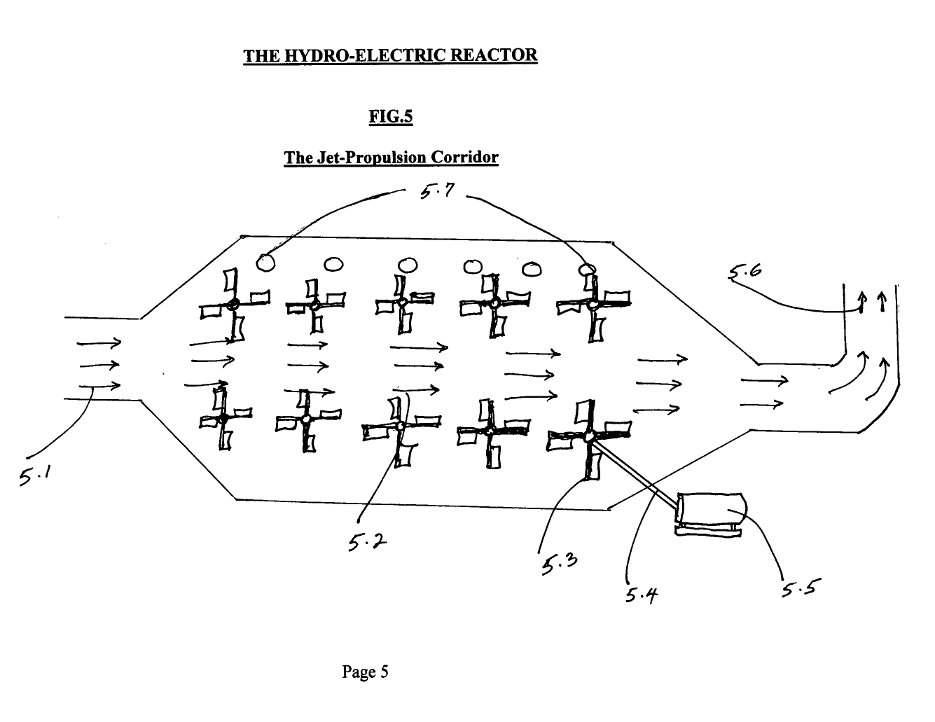

FIG. 5 Is a cross-sectional view of the Jet-Propulsion Corridor, where a series of specialized turbines are arranged in sequence in order to receive compressed air from the Multiple-Compression Chamber and rotate simultaneously to drive shaft, connecting the turbines and the generators, in order to produce electricity in large quantities.

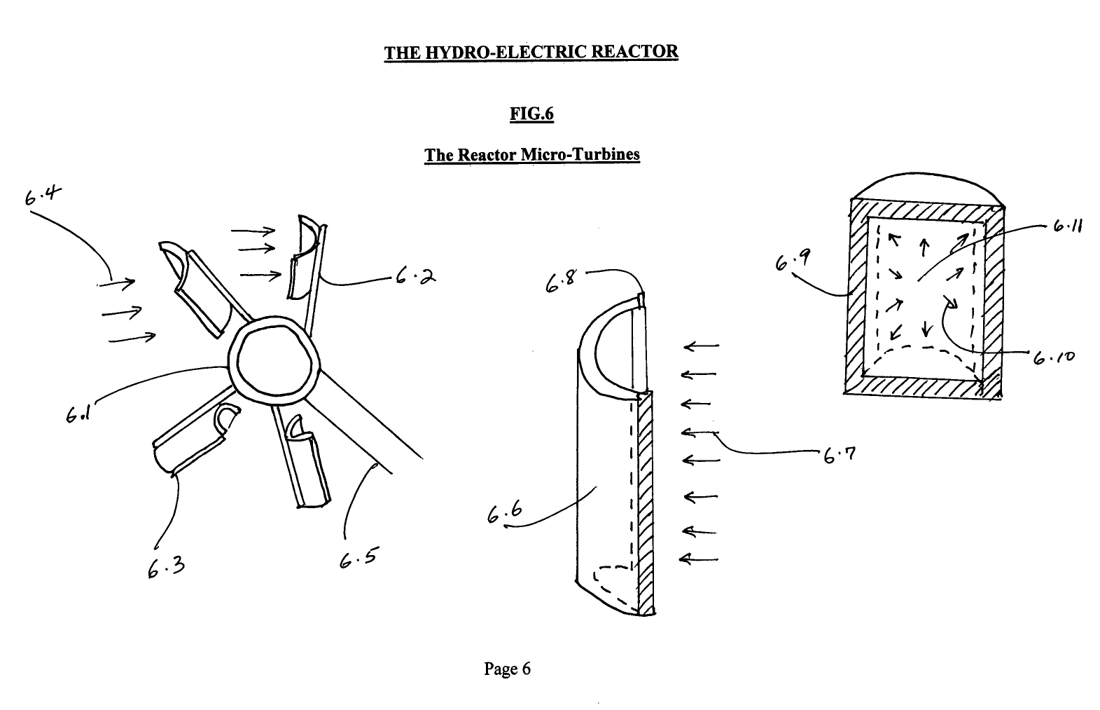

FIG. 6 Shows multiple views of the specialized turbines called Micro-Compressor Turbines which are shaped in semi-circular patterns in order to contain and further compress the incoming compressed air and provide enough torque to rotate the shafts attached to them.

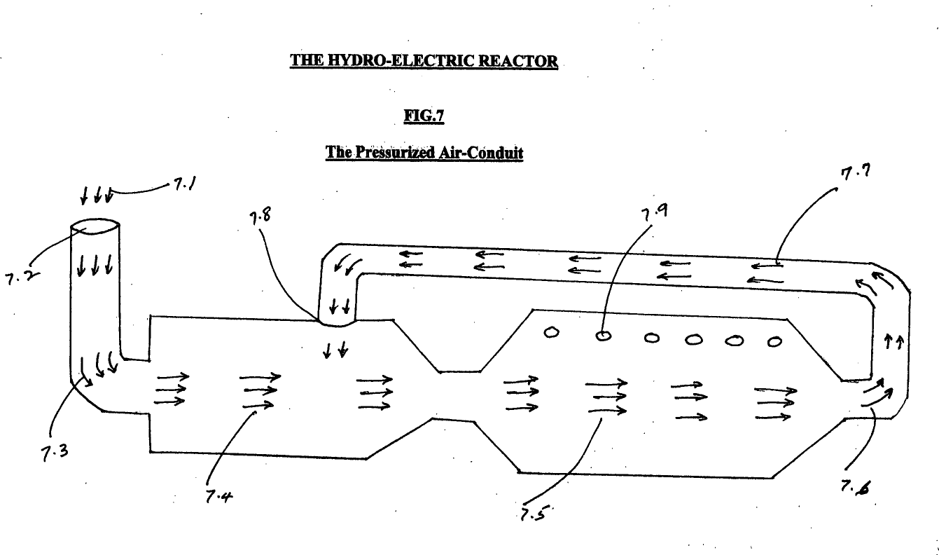

FIG. 7 Shows a cross-sectional view of how the entire principle works to create electricity without the use of any fossil fuel. The Hydro-Electric Reactor technology works by constantly compressing air at various stages in order to provide enough force to drive shafts attached to generators to provide electricity.

### DETAILED DESCRIPTION

The Hydro-Electric Reactor is an energy-producing technology which uses only compressed air, at four different stages, to generate electricity in commercial quantities. The power plant produced by this technology does not use any water, coal, natural gas, uranium or any other fossil fuels to generate electricity. Only ambient air, indoors or outdoors, is used to provide the fuel necessary to get the Hydro-Electric Reactor up and running. The word Hydro does not denote the use of water; it is simply part of the title used for the invention.

The Hydro-Electric Reactor is made up of five different sections namely: The Vertical Air-Intake Safety Vent, The Multiple-Compression Chamber, The Jet-Propulsion Corridor, The Pressurized Air-Conduit and The Air-Decompression Vents.

The technology operates on a principle known as Multiple-Compression-Propulsion-System.

FIG. 1 Is an illustration of how the technology works.

FIG. 1.1 Shows ambient air that is vertically sucked into the Hydro-Electric Reactor power plant through a protective grill FIG. 1.2 which prevents any objects standing in front or around the Reactor from being sucked into the power plant from a horizontal position. FIG. 1.3 is the funnel-shaped Vertical Air-Intake Safety Vent which allows ambient air from the atmosphere to flow through the vertical funnel. FIG. 1.4 is a powerful electric motor which drives the entire shaft FIG. 1.11 and its attached components, that spin at very high revolution. The air-intake fan FIG. 1.5 relays the ambient air into a set of compressors FIG. 1.6 which compress the air at a very high speed into the Multiple-Compression Chamber FIG. 1.8.

A high-powered battery or external power source FIG. 1.7 is used to jump-start the electric motor FIG. 1.4 which rotates the air-intake fan and the compressors at high speed before some of the electricity eventually produced by the Hydro-Electric Reactor is re-routed to take over and provide a steady flow of energy to the compressors and make the power plant self-sustaining without using any external power source.

FIG. 1.9 shows the Blow-Back Barriers which are installed within the Multiple-Compression Chamber FIG. 1.8 and act to redirect on-rushing pressurized air coming into the chamber from the compressors, directly in front of a horizontal, high-velocity, high-pressure fan FIG. 1.10, attached to the end of the shaft FIG. 1.11 driving the compressors which pushes the pressurized air with great force through a nozzle FIG. 1.12, into the Jet-Propulsion Corridor FIG. 1.13.

The Jet-Propulsion Corridor is a cylindrical or rectangular metal housing made of steel or other tough metal which allows the highly pressurized air FIG. 1.14, coming through the nozzle of the Multiple-Compression Chamber, to drive a network of specially designed Micro-Turbines FIG. 1.15 to rotate at high speed and drive the shaft and generator FIG. 1.16 attached to the ends of each turbine, to produce electricity in commercial quantities. The number of Hydro-Electric Reactor Micro-Turbines and generators will determine the output of each power plant. The more turbines and generators installed on the Jet-Propulsion Corridor, the more electricity the Hydro-Electric Reactor power plant unit will produce.

FIG. 1.17 shows the exhausted pressurized air leaving the end nozzle of the Jet-Propulsion Corridor into a recycling pipeline FIGS. 1.18 and 1.19 known as the Pressurized Air-Conduit which takes the exhaust air at high speed and pressure back into the Multiple-Compression Chamber through an opening FIG. 1.20 at the top of the Chamber, to be recycled back into the Hydro-Electric Reactor power plant unit.

FIG. 1.21 shows the Air-Decompression Vents which are located on the upper section of the Jet-Propulsion Corridor FIG. 1.13 which take away excessive pressure from within the Corridor back into the atmosphere to prevent the entire Hydro-Electric Reactor power plant unit from blowing apart. The air released from the Air-Decompression Vents is sucked back into the Reactor through the front of Vertical Air-Intake Safety Vent and the whole air-recycling process is continued again, indefinitely generating electricity. The Hydro-Electric Reactor is not a perpetual motion machine because it uses air as fuel to drive its engine. However, since air is inexhaustible in the atmosphere, the Reactor's source of fuel is limitless.

Also, units of the Hydro-Electric Reactor can be coupled together indefinitely by removing their Pressurized Air-Conduits at the nozzle of the Jet Propulsion Corridors and attaching independent power plant units to each other.

FIG. 2 Shows the Vertical Air-Intake Safety Vent which can be made of steel, aluminum, platinum or any other solid metal and it is shaped like a funnel or chimney and its function is to cover the front of the Hydro-Electric Reactor power plant unit and prevent articles or any human being from being sucked into the compressors. It allows ambient air FIG. 2.1 to be sucked into the Hydro-Electric Reactor from a vertical position rather than a horizontal one through a steel mesh or grill FIG. 2.2 which is placed at the top of the vent in order to stop large objects from being sucked into the Hydro-Electric Reactor power plant. FIG. 2.3 is the body of the vent housing which allows air FIG. 2.4 to be sucked in at high pressure through a curvature FIG. 2.5 and into the next section of the Hydro-Electric Reactor called the Multiple-Compression Chamber.

FIG. 3 Shows the Multiple-Compression Chamber which is designed like a conventional aircraft jet engine but without the combustion chamber and without using any aviation fuel. The combustion chamber has been removed and replaced with a Compression Chamber where air is compressed, rather than expanded by heat, and forced through a nozzle.

FIG. 3.1 shows air received from the Vertical Air-Intake Safety Vent and sucked in by the Air-Intake Fan FIG. 3.2 into a series of compressors and stators mounted on a rotating drum FIG. 3.3 and the compressor blades FIG. 3.4 compress ambient incoming air into a great driving force FIG. 3.5 which is forced into the Multiple-Compression Chamber FIG. 3.6. Several steel barriers positioned at precise angles FIG. 3.7 receive the onrushing pressurized air from the compressors and redirect the air FIG. 3.8 in front of a horizontal high-velocity, high-pressure steel fan FIG. 3.9 attached to the shaft FIG. 3.10 of the rotating drum on which the compressors are mounted, and the fan, rotating at very high speed, force all air received, at high pressure in a horizontal forward direction FIG. 3.11 through a nozzle, into the next section of the Hydro-Electric Reactor power plant unit.

FIG. 4 Shows the Compression Chamber which is the detailed backend of the Multiple-Compression Chamber described in FIG. 3. The Compression Chamber is designed to replace the internal combustion chamber in a conventional aircraft jet engine by removing the need to use any type of fossil fuels to propel or produce air pressure. The Chamber receives compressed air from three directions, front, back and top, and releases the pressurized air through a narrow passage or nozzle to create maximum force or thrust at the exit of the nozzle.

FIG. 4.1 is the tail-end of a long shaft which begins from the Air-Intake Fan, through the metal drum on which the compressors are mounted and the shaft rotates at the same speed at which the compressors rotate. The electric motor FIG. 1.4 provides power and rotates the shaft and all its attached components, at a very high speed to produce the right amount of pressure needed to rotate the Micro-Turbines inside the Jet-Propulsion Corridor.

FIG. 4.2 is a strong metal propeller that spins at the end of the shaft to apply horizontal pressure on all compressed air coming from three different directions into the Compression Chamber.

FIG. 4.3 shows air rushing into the Compression Chamber from the frontal compressors and the compressed air is redirected backwards towards the propeller by angular solid metal plates FIG. 4.4 known as the Blow-Back Barriers and the additional compressed air produced, is pushed forward FIGS. 4.5 and 4.6 through the nozzle FIG. 4.7 into the next section of the Hydro-Electric Reactor.

FIG. 4.8 shows an opening at the top of the Compression Chamber connected to the Pressurized Air-Conduit FIGS. 1.18 and 1.19 by a pipeline which allows pressurized incoming exhaust air FIG. 4.9 to be put back into the Compression Chamber and recycled throughout the Hydro-Electric Reactor power plant unit.

FIG. 5 Shows the Jet-Propulsion Corridor which is essentially a steel or solid metal housing which internally contains specially fabricated Hydro-Electric Reactor Micro-Turbines that are attached to external generators, through shafts, that produce electricity.

FIG. 5.1 indicates pressurized air coming into the Jet-Propulsion Corridor from the Multiple-Compression Chamber in FIG. 3 and are directed horizontally FIG. 5.2 through a network of specially designed rotating Micro-Turbines FIG. 5.3. The Reactor's Micro-Turbines are attached to long shafts FIG. 5.4 which protrude outside the Jet-Propulsion Corridor housing and are attached to generators FIG. 5.5 which produce electricity when the Micro-Turbines begin to rotate from contact with the pressurized horizontal air-flow at the center of the Corridor. The Micro-Turbines can be arranged in different configurations but the essential point is that they must all face the incoming pressurized air in the same direction.

FIG. 5.6 Shows the exhausted pressurized air leaving the Jet-Propulsion Corridor through a nozzle into a pipeline that recycles the air back into the Multiple-Compression Chamber.

FIG. 5.7 Shows the Air-Decompression Vents which allow excess air inside the Jet-Propulsion Corridor to escape back into the atmosphere in order to prevent the Corridor from being over-pressurized and causing an explosion of the entire Hydro-Electric Reactor power plant unit.

FIG. 6 Shows several facets of the Hydro-Electric Reactor Micro-Turbines which are designed to use small turbines to do the work of large turbines without the need to take up too much space. The Reactor's Micro-Turbines are the key components that allow the Hydro-Electric Reactor technology to use little amount of power to generate maximum electricity.

FIG. 6.1 Shows the circular steel hub upon which each blade of the Micro-Turbines are attached using the stem FIG. 6.2 to hold the semi-circular shaped steel Micro-Turbine in place.

FIG. 6.3 is the Micro-Turbine shaped like a sail, with the wind inside, in order to collect pressurized air FIG. 6.4 coming in the opposite direction and spread the compressed air evenly through the semi-circular inner surface of the Micro-Turbine.

FIG. 6.5 Is the shaft to which the Micro-Turbines are attached and which is connected to an external generator as in FIG. 5.5.

FIG. 6.6 Shows the back view curvature of the Micro-Turbine and FIG. 6.7 shows pressurized air flow which goes into the semi-circular Micro-Turbine and the air is further compressed inside the Micro-Turbine interior to provide the powerful torque necessary to rotate the shaft and generate electricity from the generators.

FIG. 6.8 Shows the external metal flange on the Micro-Turbine which acts as a fan moving backwards when the Micro-Turbine is rotating to apply air pressure to the next turbine which enables the entire network of Micro-Turbines to receive adequate relays of pressurized air to rotate evenly.

FIG. 6.9 Shows the internal metal flange welded onto the Micro-Turbine outer surface and overlapping across it and they serve to push back escaping pressurized air into the inner semi-circular cavity of the turbines in order to add pressure inside each Micro-Turbine and rotate the shaft attached to the external generator to produce electricity. The stronger the amount of torque (force) applied by the Micro-Turbines on the shafts, the more powerful will be the generators needed to produce more electricity.

FIG. 6.10 Shows the multiple directions in which compressed air flows within the semi-circular center of the Micro-Turbine and FIG. 6.11 indicates the inner cavity of the Hydro-Electric Reactor's specially designed Micro-Turbine.

FIG. 7 Shows the function of the Pressurized Air-Conduit which serves to recycle exhaust compressed air from within the entire Hydro-Electric Reactor power plant unit and supply maximum air pressure to the Jet-Propulsion Corridor, through the Multiple-Compression Chamber in order to turn the Micro-Turbines, inside the Corridor, which rotate the shafts at high speed to produce electricity from the external generators.

FIG. 7.1 Shows the beginning of the process whereby ambient air is sucked into the Reactor through the Vertical Air-Intake Safety Vent FIG. 7.2 into the funnel FIG. 7.3 and the air is sucked into the Multiple-Compression Chamber FIG. 7.4 and the compressed air continues into the Jet-Propulsion Corridor FIG. 7.5 then into the Pressurized Air-Conduit FIGS. 7.6 and 7.7 and finally makes its way back into the Multiple-Compression Chamber through a vent or opening FIG. 7.8 at the top of the Chamber and the pressurized air-flow process is repeated again throughout the life-cycle of the Hydro-Electric Reactor power plant unit.

FIG. 7.9 Shows the Air-Decompression Vents which are several openings at the upper section of the Jet-Propulsion Corridor which allow some amount of pressurized air to escape from the Hydro-Electric Reactor back into the atmosphere in order to prevent the power plant unit from exploding due to excessive pressure.

### FIELD OF THE INVENTION

The Hydro-Electric Reactor relates to the field of renewable energy commonly referred to as Green Energy which is designed to replace the expensive and ecologically harmful fossil fuel-based energy generating systems currently used all over the world.

It covers the broad area of electricity generation for the purpose of providing clean green power for residential, commercial and industrial consumption utilizing renewable resources which are easy to extract and easier to replace without polluting the atmosphere with harmful toxic substances like lead, sulfur, carbon dioxide and other harmful gases which not only cause major health problems to human populations across the world but also deplete the ozone layer that prevent harmful ultra-violet rays emitted from the sun to reach the earth's surface and caused skin cancer to humans.

These substances are also known to cause the so-called Greenhouse effect which negatively impacts the earth's climate.

The Hydro-Electric Reactor is a new technology which uses only ambient air from the atmosphere to generate electricity through a process known as the Multiple-Compression-Propulsion-System. The system enables the technology to compress air in four stages through segments of the Hydro-Electric Reactor and the compressed air is then used to turn specially designed Micro-Turbines, which have electricity generators attached to them, with shafts, to produce electricity in commercial quantities.

### PRIOR ART

The known prior art are in the following areas:
1. Wind Turbine Generators which produce electricity at specially designated wind passages along coastlines and mountains and are known as Wind Farms.
2. Solar Energy is another source of renewable energy technology which converts sunlight into chemical energy which is further converted into electrical energy stored in a network of rechargeable batteries. This technology is only viable where sunshine is consistent during the daytime but it is known that batteries are easily depleted and the cost of installing solar panels to collect and convert sunlight is quite prohibitive.
3. Geo-Thermal Power Plants use the hot molten magma inside the earth's crust to heat water, contained inside a network of pipelines running deep inside the earth, which is converted into steam to drive steam turbines to generate electricity.

### BACKGROUND OF THE INVENTION

Since the invention of the Steam Engine and the Internal Combustion Engine, mankind has been searching for a reliable, cheap and consistent form of energy which will provide an acceptable alternative to the present forms of generating energy.

Fossil fuels, in the form of carbon-based petroleum, natural gas, coal, shale and others have provided the cheapest and most abundant form of fuel to drive different forms of energy-producing power plants all over the world.

The drawbacks, however, to these fuels is that they are easily depleted through mass-exploitation and are very difficult to replace. Furthermore, they cause harmful problems to both human beings and other animals and also destroy the earth's precious ozone layer which protects the earth from direct contact with harmful ultra-violet rays from the sun.

To solve these problems, the Hydro-Electric Reactor was developed to provide a viable, reliable, cheap and clean source of energy that can produce electrical power using only compressed atmospheric air and discharging excess air into the atmosphere. No harmful chemicals are used to generate electricity with this technology and air is in abundant supply throughout the world.

What is claimed:

1. A system of generating electricity without using any fuels, only air pressure that is created by a Multiple-Compression Chamber which compresses ambient air in several stages to provide maximum pressure sufficient to drive a network of specially designed Micro-Turbines attached to external generators, through shafts, to produce electricity in large quantities.

2. A compressed air projection passage, with specialized Micro-Turbines, known as the Jet-Propulsion Corridor which allows pressurized air emerging from the Multiple-Compression Chamber, to be directed along a corridor containing a network of specially designed Micro-Turbines which are shaped in the form of semi-circular buckets to receive compressed air and with internal and external flanges to pressurize the turbines to rotate and drive the shafts attached to generators to produce electricity in commercial quantities.

3. A pipeline that recycles exhaust compressed air known as the Pressurized Air-Conduit which takes the pressurized air emerging from the exhaust nozzle of the Jet-Propulsion Corridor, back into the Multiple-Compression Chamber to be recycled, compressed and forced back into the rotating Micro-Turbines contained inside the Jet-Propulsion Corridor in order to provide additional air pressure and produce electricity from attached generators, through a constant recycling of pressurized air.
